(19) United States
(12) Patent Application Publication
(10) Pub. No.: US 2008/0108313 A1
(43) Pub. Date: May 8, 2008

(54) Systems and Methods for Manufacturability and Serviceability of Communication Device(s)

(75) Inventors: Edward R. Soares, Lompoc, CA (US); David L. Aidnik, Santa Barbara, CA (US)

Correspondence Address: WOLFF LAW OFFICE, PLLC, P.O. BOX 9855, CHAPEL HILL, NC, 27515-9855, US

(73) Assignee: Superconductor Technologies, Inc.

(21) Appl. No.: 11/934,639

(22) Filed: Nov. 2, 2007

Related U.S. Application Data
(60) Provisional application No. 60/864,083, filed on Nov. 2, 2006.

(51) Int. Cl. H04B 1/40

(52) U.S. Cl. 455/90.2

(57) ABSTRACT

The present invention is directed generally to providing systems and methods for designing a communication system that is both modular and easy to service. As such, the present invention includes various embodiments showing methods, systems, and apparatus for manufacturing and servicing a communications system(s) that may, at least in part, include a non-permanent connection interface between components that facilitates assembly and/or disassembly of components within a receiver front end in a telecommunication system(s). For example, in at least one embodiment, a female sleeve connection is integrated into a filter, duplexer, and/or multiplexer housing and provides a non-permanent connection interface with a male connection post integral to a radio frequency amplifier to improve both modularity and serviceability of a communication system. The communication system may be, for example, a front end receiver in a cellular communication system.

The present patent application claims priority to U. S. provisional patent application Ser. No. 60/864,083, filed on Nov. 2, 2006, the entire contents of which are incorporated herein by reference.

### FIELD OF THE INVENTION

The present invention relates to the field of communications, and more specifically, to systems and methods for improved manufacturability and serviceability of communication devices.

### BACKGROUND

Today there are numerous types of electronic or electronic assisted communication systems that include, for example, radio, television, cable, internet, two-way radio, cellular telephone systems, LANS, WANS, and optical communication systems. Many of these systems may employ various types of signal amplifiers, filters and/or multiplexers in their receivers and transmitters. Often these systems and devices are highly integrated and many of the components are manufactured so that they may not be easily serviced or repaired. For example, many discreet components, connectors, and wiring are typically soldered together or assembled in a somewhat permanent manner so that they can not easily be maintained or repaired in the field, if at all. In fact, many of the communication systems today have components that are packaged in a way that makes any maintenance or repair not reasonably possible or viable; enclosures, casings or housings are often sealed using welding or numerous screws or bolts. In fact, if a component(s) in communication systems today stop working properly, it is often disposed of and replaced by a complete new component(s), rather than replacing a sub-component.

In particular, today's cellular telephone systems may have ground or tower top mounted receiver and transmitter components, for example, receiver front ends that may include filter(s)/amplifier(s). However, these units are typically highly integrated and have their internal components soldered or welded together so that they are difficult to service and/or repair. Further, their enclosure housings are typically sealed by welding and/or numerous screws or bolts. In addition, the tower mounted units are difficult to access because they are place high (e.g., 100 feet in the air) up on the cell tower at base stations and must be accessed or removed with a crane. Finally, receiver front end systems typically need to be properly tuned if various components are repaired or replaced. The invention of the present application addresses these limitations by presenting systems and methods for designing a communication system(s) with a system and components that are designed to be modular, easy to service, and/or easy to repair, and do not require the system to be tuned after service and/or repair.

### SUMMARY

The present invention is directed generally to providing systems and methods for designing a communication system(s) that is both modular and easy to service. Specifically, the present invention is directed to, for example, providing a non-permanent connection interface between components including, but not limited to, radio frequency amplifiers, couplers, switches, VSWR alarms, mixers, and isolators and various receiver system components in an electronic and/or communication network(s) or system(s). In various embodiments, the non-permanent connection interface facilitates assembly and/or disassembly of components within a receiver front end in a telecommunication system(s). In one variation, a housingless pin(s) and sleeve(s) connection or coupling system may be used to interconnect system components. The sleeve may be encased within the housing of, for example, a filter, duplexer, and/or multiplexer and provide a non-permanent connection interface between, for example, the filter, duplexer, and/or multiplexer and a radio frequency (RF) signal amplifier. The pin may be attached to a circuit board of the RF amplifier. In one variation, the RF amplifier may be a low noise amplifier (LNA). The pin(s) and sleeve(s) connector coupling system results in a highly repeatable low resistant and low reflection connection so that the RF amplifier and filter, duplexer and/or multiplexer may be tuned independently and assembled together without retuning. As such, the invention is particularly useful for maintaining repeatable Radio Frequency (RF) signal characteristics across a wide range of communication system components, and particularly with signal filters and amplifiers. In one variation, an electronics board and a radio frequency amplifier may be on separate boards, thus resulting in easily accessible and removable system components in a communication system(s) housing.

Various embodiments of the present invention include a front end receiver in, for example, a base station in a cellular communication system. The base station may include use of HTS filters. The present invention is also useful in various other electronics and communication systems. For example, a point-to-point communication network(s) (communications between two non-mobile locations), a wireless computer network(s), etc., where a repeatable, removable, high quality connection or coupling system is needed.

Still further aspects included for various embodiments will be apparent to one skilled in the art based on the study of the following disclosure and the accompanying drawings thereto.

### BRIEF DESCRIPTION OF THE DRAWINGS

The objects, features and advantages of the present invention will become more readily apparent to those skilled in the art upon reading the following detailed description, in conjunction with the appended drawings, in which:

FIG. 1 illustrates a partial perspective view of a coupling post and connection sleeve installed in a filter, duplexer, and/or multiplexer, according to at least one embodiment of the invention;

FIG. 2a illustrates a perspective view of a portion of a filter, duplexer, and/or multiplexer including one or more filters, according to at least one embodiment of the invention;

FIG. 2b illustrates a magnified perspective view of the end of a filter, duplexer, and/or multiplexer where a radio frequency amplifier attaches, according to at least one embodiment of the invention;

FIG. 3 illustrates a perspective view of a test/tuning signal connector and a coupling post and connection sleeve, according to at least one embodiment of the invention;

FIG. 4a illustrates a perspective view of a back plate of a radio frequency amplifier with two male connection posts, according to at least one embodiment of the invention;

FIG. 4b illustrates a magnified perspective view of one of the male connection posts of a radio frequency amplifier, according to at least one embodiment of the invention;

FIG. 5 illustrates a perspective view of the back of a receiver enclosure including an indication of the assembly of components, according to at least one embodiment of the invention;

FIG. 6 illustrates a perspective view of the back of a receiver enclosure, depicting the attachment of a radio frequency amplifier(s), e.g., LNAs, to one end of a filter, duplexer and/or multiplexer(s), according to at least one embodiment of the invention; and

FIG. 7 is an exemplary flowchart of one of the methods of the invention, according to at least one embodiment.

### DETAILED DESCRIPTION

The present invention is directed generally to providing systems and methods for designing electronics and/or communication system(s) that are both modular and easy to manufacture, service, and repair. As such, the present invention includes various embodiments showing methods, systems, and apparatus for manufacturing and servicing electronics and/or communications system(s) that may, at least in part, include a non-permanent connection interface between components that has high quality low resistant and low reflection repeatable connection that facilitates assembly and/or disassembly of components within, for example, a receiver front end in a telecommunication system(s). For example, in various embodiments, a female sleeve connection, without a separate connector housing, is integrated into a filter, duplexer and/or multiplexer housing. As such, the female sleeve connection provides a non-permanent connection interface with a male connection post. The male connection post may be, for example, integral to a radio frequency amplifier which may improve both modularity and serviceability. In one variation, the female sleeve connection may include a spring tension mechanism. The invention is particularly useful for maintaining repeatable Radio Frequency (RF) signal characteristics across a wide range of interchangeable filters, duplexers, multiplexers, and/or amplifiers. The invention is also particularly beneficial in providing a means by which components within a communication system, for example, a radio frequency amplifier and an electronics board or circuit board assembly, are easily accessible, removable, and replaceable. This is especially useful for serviceability, maintenance, and upgrades of systems installed in the field. With the system installed such that there is easy access to the access panel or door, the system may be serviced, maintained, or upgraded without having to break the connections to a receiver, such as used in a cellular network base station. Not having to uninstall the system to repair, service or upgrade it leads to faster repair times and less downtime for the base station.

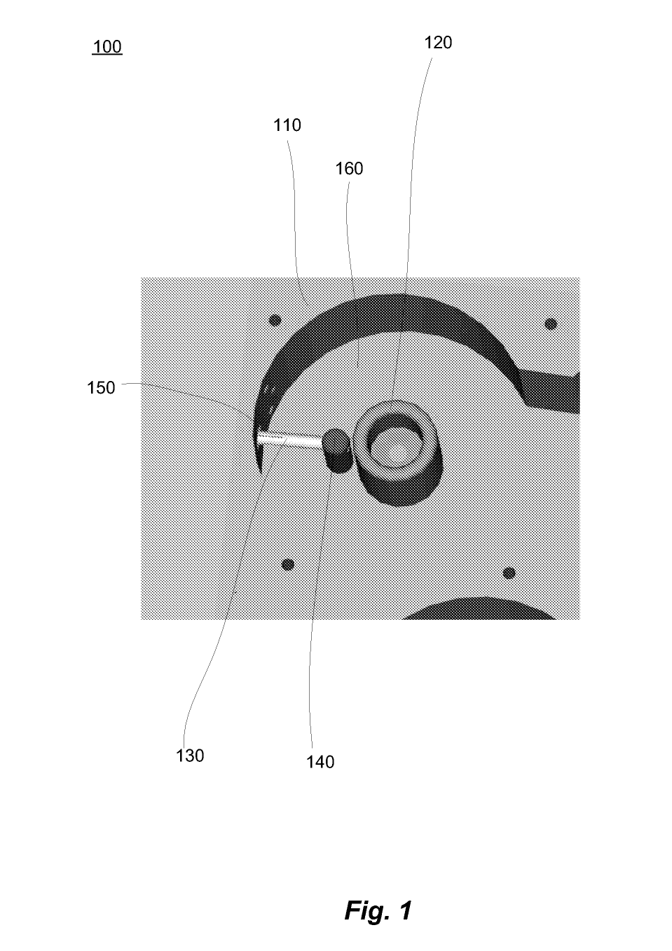

Referring to FIG. 1, a perspective view 100 of a coupling post 140 next to a resonator 120 in a portion of a filter, duplexer and/or multiplexer housing 110 is shown. The coupling post 140 may be magnetically coupled to the resonator 120. The coupling post 140 may also be securely attached to the floor 160 of the filter, duplexer and/or multiplexer housing 110 by means of, for example, a screw, bolt, welding, etc. A female connection sleeve 130 is securely affixed, for example, by solder, via a threaded connection, etc., to the coupling post 140. In one embodiment, the female connection sleeve 130 may incorporate a spring tension mechanism. For example, the female sleeve may include one or more slots or separation areas 150 along its axial length, that allows the various parts to flex when the male pin is inserted into the female sleeve 130. As such, the female connection sleeve 130 may provide spring tension to its internal circumference so as to firmly attach to and grip a male counterpart that is inserted into the female sleeve 130.

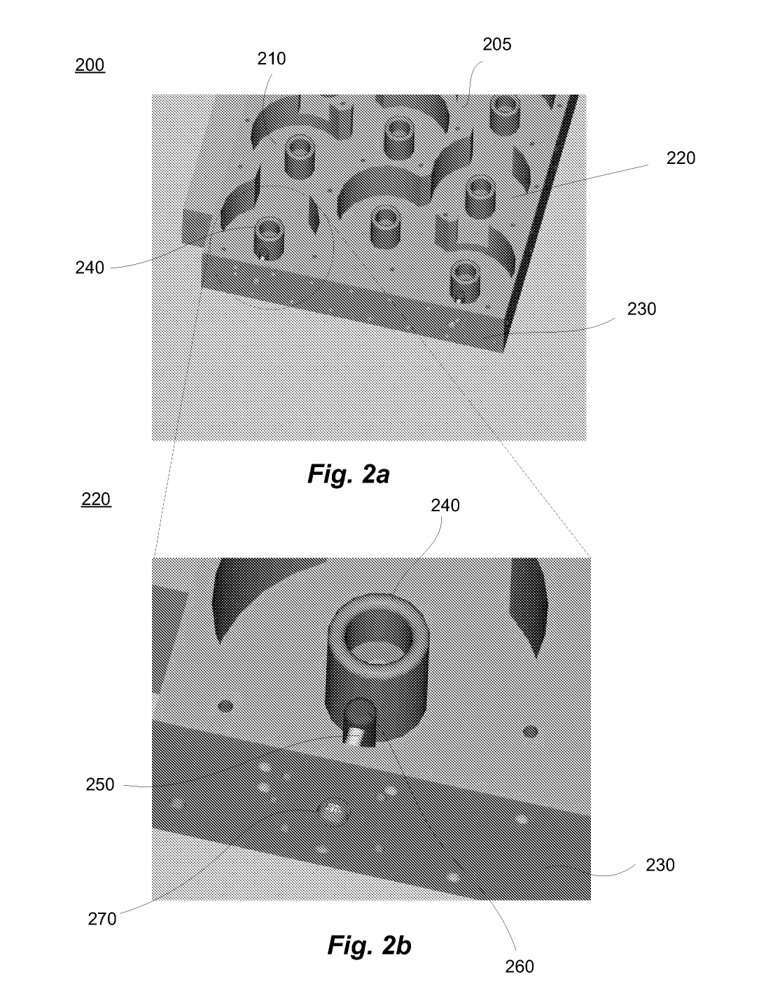

Referring to FIG. 2a, a partial perspective view 200 of a portion of a filter, duplexer, and/or multiplexer 200 is provided. There may be two coupling posts in each filter, duplexer, and/or multiplexer 200. The filter, duplexer or multiplexer 205 may include one or more filters, comprised of a plurality of filter cavities, e.g., 205, 210, 220 and a plurality of resonators, e.g., resonator 240. In this view, resonator 240 is shown at one end of a filter cavity 210. Another filter cavity 220 with multiple resonators is also shown. One end 230 of the filter, duplexer, and/or multiplexer housing 200 where a RF amplifier attaches is also shown.

Referring to FIG. 2b, a magnified perspective view 220 of FIG. 2a shows the end 230 of a filter, duplexer, and/or multiplexer 200 where a radio frequency amplifier (not shown) may be attached. A coupling post 260 is affixed at its base to the floor of the filter, duplexer and/or multiplexer housing 110 within the filter cavity. It may be securely fastened to the housing using a screw, bolt, soldering, welding, etc. A female connection sleeve 250 is securely mounted to the coupling post 260. In one embodiment of the present invention, the female connection sleeve 250 may be comprised of one solid portion and one hollow portion, the hollow portion may contain a spring tension mechanism and be accessible for connection. Of course, in various embodiments the female connection sleeve 250 may be made of a shaft that is hollow from one end to the other. The female connection sleeve 250 may protrude into an access/through/via hole 270 at one end 230 of the filter, duplexer, and/or multiplexer housing 110, the open end of the sleeve 250 may be set back from the outer edge of the filter, duplexer, and/or multiplexer housing 110 by, for example, approximately 5 mils. The outer surface(s) of the female connection sleeve 250 may be surrounded by but is insulated from the filter, duplexer, and/or multiplexer housing. For example, in various embodiments the female connection sleeve 250 may be surrounded by but does not touch or in any way connect with the inner duplex housing surface(s) of the access/through/via hole 270 in an electrical conductive manner. The circumference of both the connection sleeve and the access/through/via hole may be established as a function of the desired impedance to which the system components are to be tuned. Although it is common practice to tune components to, for example 50 ohm, any desired impedance may be accommodated. In various embodiments, there is no housing or other physical encasement surrounding the female connection sleeve. Air, or other nonconductive or dielectric material, may be used to insulate the female connection sleeve from the filter, duplexer, and/or multiplexer housing 110. The female connection sleeve may retain its position relative to the access/through/via hole 270 by way of the attachment of the female connection sleeve to the coupling post. The outer most open edge of the female connection sleeve 250 may be flared or tapered outward to facilitate a smooth and repeatable insertion of a male post or pin that completes the connection system. The male connection post or pin (not shown in FIG. 2b) may be included on a radio frequency amplifier (not shown in FIG. 2b) and may interface with the female connection sleeve 250, thus providing a non-permanent connection interface between, for example, a filter, duplexer, and/or multiplexer and a radio frequency amplifier.

One exemplary method of assembling the coupling post and female connection sleeve into the filter, duplexer, and/or multiplexer is described as follows. The coupling post 260 may be attached to the floor of the filter, duplexer, and/or multiplexer housing 110 with, for example, a screw(s), bolt, welding, etc, so it is securely fastened. The connection sleeve 250 may be inserted into a cross-drilled hole in the coupling post 260. An assembly fixture may then be used to align the connection sleeve 250 with respect to the hole 270 in the filter, duplexer, and/or multiplexer housing body 110 so that the connection sleeve 250 is concentric with the hole in one side, e.g., end 230, of the filter, duplexer, and/or multiplexer housing body 110. Once the connection sleeve 250 is aligned, the screw(s) holding the coupling post may be fully tightened. The connection sleeve 250 may then be, for example, soldered to the coupling post 260. The assembly fixture may then be removed, while the connection sleeve retains its alignment with respect to the hole in the filter, duplexer, and/or multiplexer housing body 110. Of course, the connection sleeve 250 and coupling post 260 may be assembled outside of the filter, duplexer, and/or multiplexer housing 110 first and then inserted and securely fastened to the filter, duplexer, and/or multiplexer housing 110.

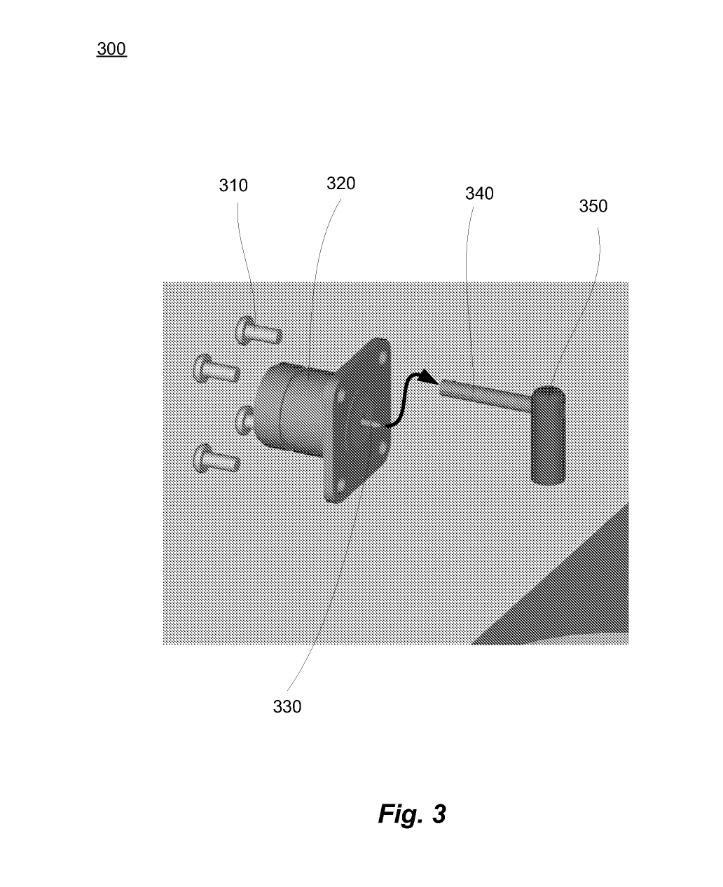

Referring to FIG. 3, a perspective view 300 of a connector 320, for example a test connector, and female sleeve 340 with coupling post 350 is shown as separate items not yet attached or coupled to the filter, duplexer, and/or multiplexer housing 110. The connector 320 may be used to tune a filter, duplexer, and/or multiplexer (not shown in FIG. 3) by connecting to the female connection sleeve 340 and coupling post 350. In one embodiment of the present invention, the female connection sleeve 340 is permanently affixed, for example, by solder, to the coupling post 350. In another possible embodiment of the invention, female connection sleeve 340 may be affixed directly to the first resonator 240 in, for example, FIG. 2b. This connection may be achieved via, for example, a threaded interface. The female connection sleeve 340 may have a threaded end while the resonator 240 may have a tapped hole into which the female connection sleeve is inserted. A radio frequency interface pin 330 on the connector 320 may be inserted into the female connection sleeve 340, thus enabling the filter, duplexer, and/or multiplexer to be tuned. Screws 310 may connect the connector 320 to the filter, duplexer, and/or multiplexer (not shown in FIG. 3) and then the connector 320 may be used to tune the filter(s), duplexer, and/or multiplexer(s) 200. Once the filter(s), duplexer, and/or multiplexer(s) 200 are tuned, the connector 320 may be removed, enabling a component, for example, a radio frequency amplifier, to be attached to the filter, duplexer, and/or multiplexer 200.

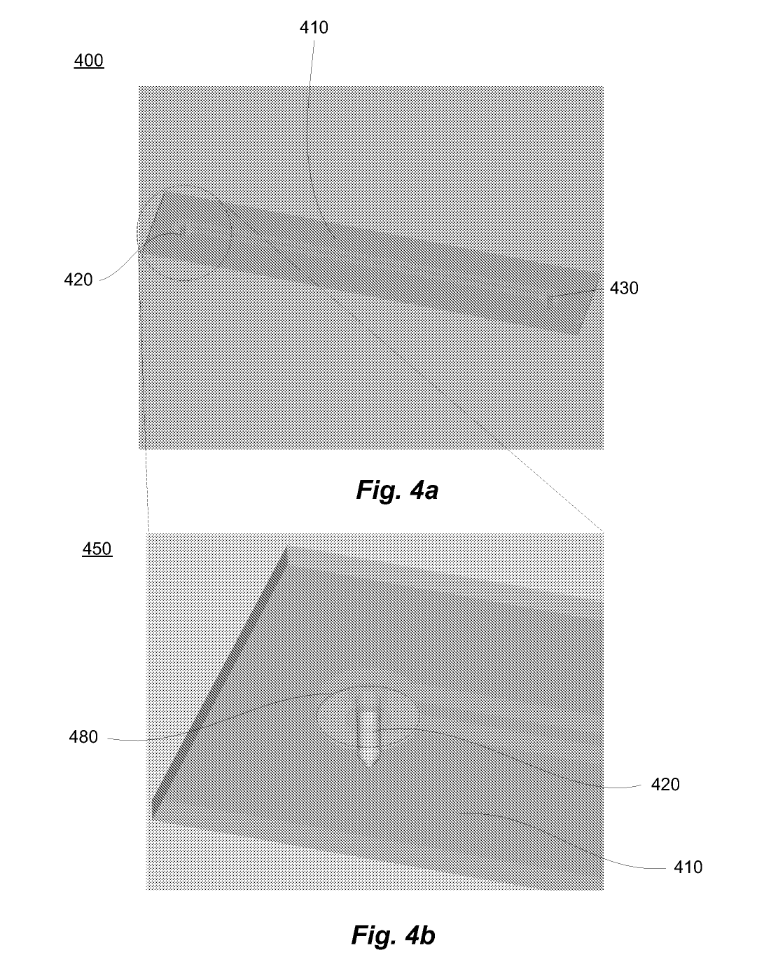

Referring to FIG. 4a, a perspective view 400 of a back plate 410 of, for example, a radio frequency amplifier with two male connection pins/posts 420 and 430 are shown. This back plate 410 may include a ground plane for interfacing with the filter, duplexer and/or multiplexer housing 110 and may mount to a housing/enclosure of an RF amplifier module. The RF amplifier module may be more generally an electronic component module and the two male connection pins/posts 420 and 430 may be coupled or connected to various electrical or electronic components that make up an electronic component module, such as an RF amplifier. The male connection pins/posts 420 and 430 may then be connected one each to, for example, female sleeves 340.

Referring to FIG. 4b, a magnified perspective view 450 of a back plate 410 of, for example, a radio frequency amplifier is shown. A male connection post 420 may protrude through a via hole in the back plate 410 of an electronic component module, for example, a radio frequency amplifier. The back plate 410 may include a grounding plate or plane that may be made of a conductive material such as metal. The metal may be formed so that it has a hole(s) 480 at the pin/post 420 location, so as not to ground out the pin/post 420. In various embodiments, the outer surface(s) of the male connection pin/post 420 do(es) not touch, or in any way connect with the ground plane through which the male connection post 470 protrudes. Although, the pin/post 420 may connect to and be held by the walls of a via hole formed in the back plate 410. The back plate may be, for example, a typical circuit board with various layers of material with isolation properties and materials with conductive properties.

One exemplary method of assembling the male connection post to an electrical component module, for example a radio frequency amplifier, is described as follows. A plated via hole is designed into a radio frequency amplifier circuit component mounting board. In the ground plane side of the board, the side that may be attached to the filter, duplexer, and/or multiplexer 200, the ground plane may be etched away from the male connection post to avoid any shorts to ground. The male connection post 420 may then be situated into the via hole and soldered in place. The male connection post 420 may then be easily inserted into the female connection sleeve, thus enabling attachment of a radio frequency amplifier to a filter, duplexer and/or multiplexer housing.

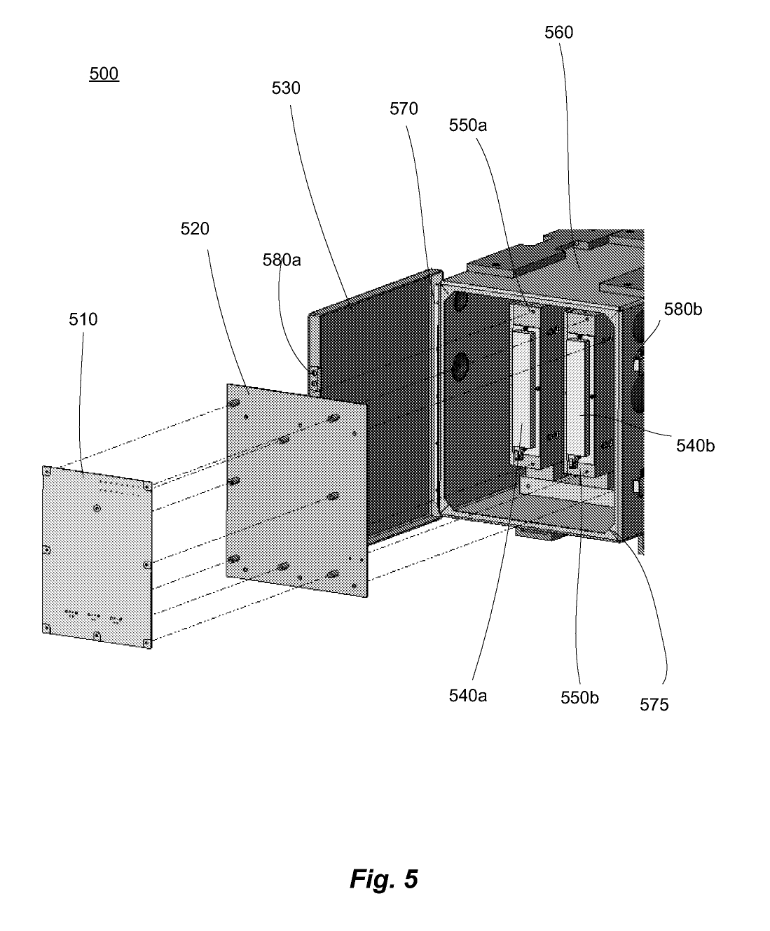

Referring to FIG. 5, a perspective view 500 of the back of, for example, a receiver enclosure 560 depicting the assembly of components within is shown. An electronics board 510 may attach to a mounting plate 520, which may be attached to one or more filter(s), duplexer(s), and/or multiplexer(s) 550a, 550b, etc. A radio frequency amplifier(s) 540a and 540b may be attached to the filter, duplexer, and/or multiplexer 550a and 550b, and may be located between the mounting plate 520 and the filter, duplexer, and/or multiplexer(s) 550a, 550b, etc. In various embodiments, the front end receiver may include three filters, duplexers and/or multiplexers and three radio frequency amplifiers, respectively. An access panel or door 530 may provide access to the components within the receiver enclosure 560. One or more hinge(s) 570 may be used to attach the access panel or door to the receiver enclosure 560 so as to give easy and quick access inside the receiver enclosure 560. There may also be one or more gaskets or seals 575 to help provide a hermetic or weather resistant seal to the door and enclosure when the door is closed and secured in place with latches 580a and 580b. This weather resistant seal may conform to, for example, one of many accepted standard such as NEMA (National Electrical Manufacturer's Association) standard 3, 3R, or 4X and may be made of a malleable material such as various types of rubbers or plastics.

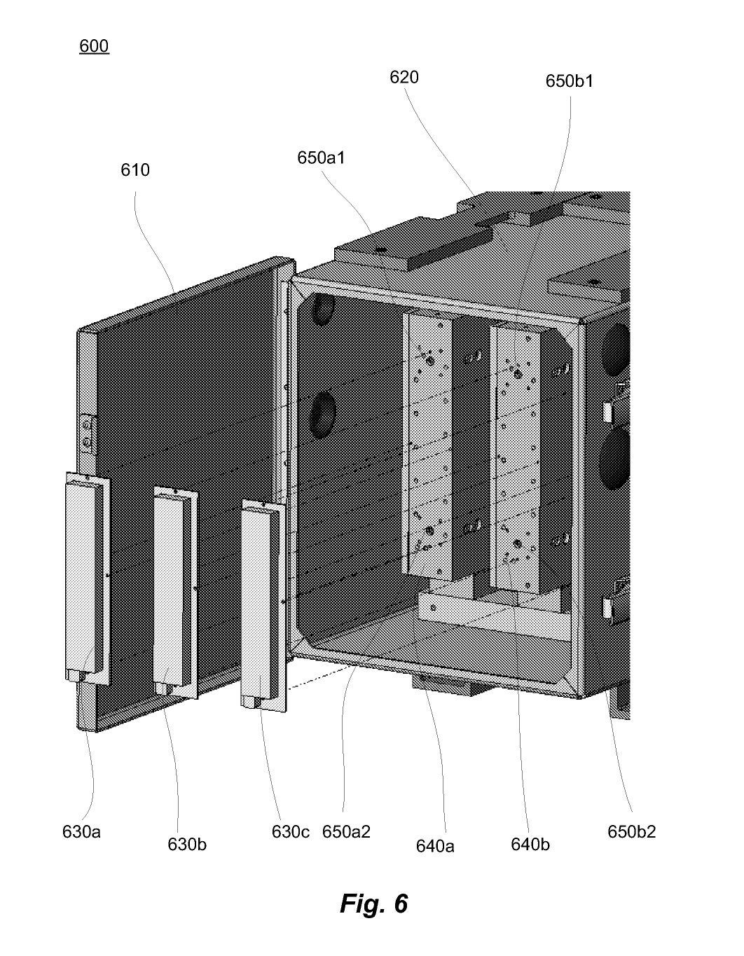

Referring to FIG. 6, a partial perspective view of the back of a receiver front end 600 with enclosure 620, depicting the attachment of a radio frequency amplifier(s) (e.g., Low Noise Amplifiers (LNAs)) 630a, 630b, 630c to one end of a filter, duplexer, and/or multiplexer(s) 640a, 640b, 640c (640c not shown) is shown. An access panel or door 610 provides access to the components. In this example, the electronics board and the mounting plate have been left out for better views of the RF filters and mounting to the filter, duplexer, and/or multiplexers. In this Figure, three LNAs, 630a, 630b, and 630c are shown. This view shows the cover side (opposite to the back plate) of the electronic component module, e.g., LNAs. When installed into the receiver front end 600, the back plate of the LNAs may fit flush against the back wall of the filter, duplexer, and/or multiplexers (630a fits to 640a, 630b fits to 640b, 630c fits to 640c (640c is not shown)) and the two male pins/posts stick through the back plate of the LNAs (e.g., 630a) will fit/slide into the two female sleeves of the respective LNA(s), e.g. 650a1 and 650a2. So, in this example, the two male pin/posts of LNA 630b will fit into the respective two female sleeves 650b1 and 650b2 of filter, duplexer, and/or multiplexer 640b. Likewise with LNA 630c and filter, duplexer, and/or multiplexer 640c (not shown in FIG. 6). In this way, only a few screws are needed to hold the electronic component modules (e.g., LNA(s)) to the filter, duplexer, and/or multiplexer(s).

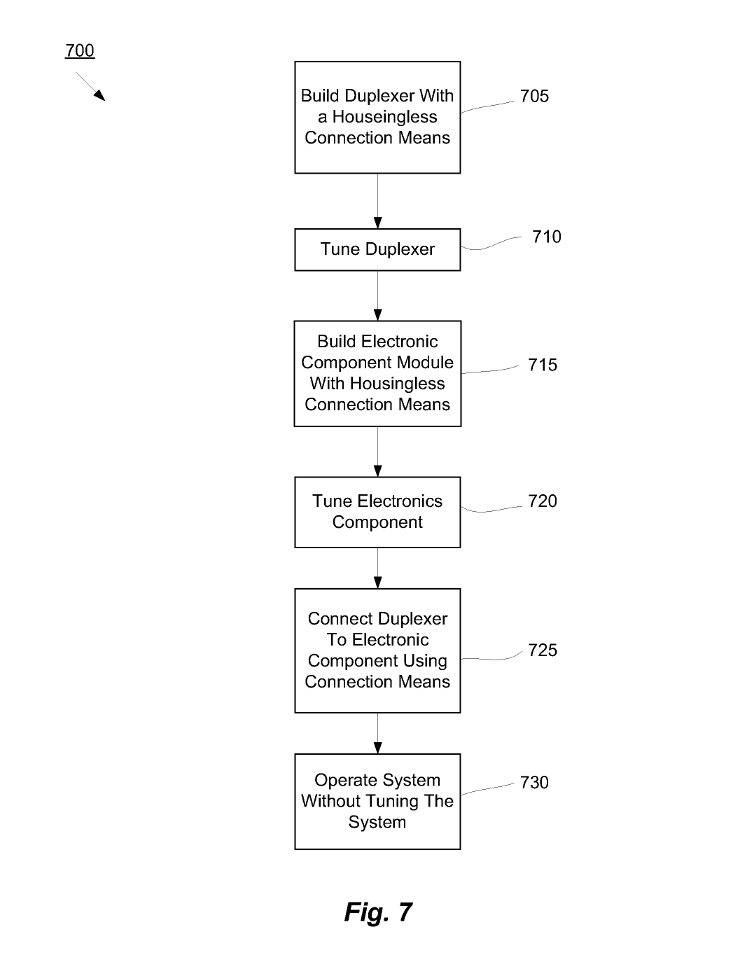

Referring to FIG. 7, one exemplary method of assembling/constructing the communication system of the present invention is described as follows. Although the term duplexer is used in the Figure, one skilled in the art would understand that this may be a filter, duplexer, and/or multiplexer (or other type of electronic system). First, as shown in 705, a duplexer, multiplexer and/or filter may be assembled and constructed which contains a housingless connector means, for example a sleeve, situated in an access/through/via hole. Next, a testing/tuning connector may be attached to the duplexer, multiplexer and/or filter and the housingless connector means. After the duplexer, multiplexer and/or filter is tuned, as shown in 710, the testing/tuning connector may be removed and the duplexer, multiplexer and/or filter may be placed into inventory. Similarly, as shown in 715, an electronic component module, for example an amplifier such as an LNA, may be constructed with one or more connection means, for example a male connector that may be a pin(s)/post(s). A testing/tuning connector(s) may be attached to the electronic component (e.g., an LNA). After the electronic component (e.g., an LNA) is tuned, as shown in 720, the testing/tuning connector(s) may be removed and the electronic component (e.g., LNA) may be placed into inventory. After both of the duplexer, multiplexer and/or filter and the electronic component (e.g., an LNA) have been constructed and tuned, the two components may be retrieved from inventory for either constructing a new system(s) or repairing an old system(s), as shown in 725. The electronic component (e.g., an LNA) may be attached to the duplexer, multiplexer and/or filter with a securing means, for example, screws, bolts, etc. The duplexer, filter and/or multiplexer and electronic component assembly may then be placed into a chassis, housing, or enclosure, and a final functional test may be performed. As shown in 730, the assembled system may be operated without subsequently tuning the system because the connection means are designed to provide low resistance and low reflection highly repeatable connections. Thus, the present invention results in systems and methods that improve manufacturability and serviceability and is particularly beneficial for systems that need tuning and for receiver front end units in cellular communication systems.

Although a particular embodiment(s) of the present invention has been shown and described, it will be understood that it is not intended to limit the invention to the preferred embodiment(s) and it will be obvious to those skilled in the art that various changes and modifications may be made without departing from the spirit and scope of the present invention. For example, the systems and methods of the present invention may also be applied to other communication networks, for example, a point-to-point communication network(s) and a wireless computer network(s). Further, although the male and female part of the connection system are shown on particular components, one skilled in the art will recognize that the male connector part may be used on the filter, duplexer, and/or multiplexer components and the female connector part may be used on the electronic component module to achieve the present invention. Thus, the invention is intended to cover alternatives, modifications, and equivalents, which may be included within the spirit and scope of the invention as defined by the claims.

All publications, patents, and patent applications cited herein are hereby incorporated by reference in their entirety for all purposes

What is claimed is:

1. A communication system, comprising:
a first connection means mounted to a filter, duplexer or multiplexer and protruding at least partially into a through hole in the filter, duplexer or multiplexer housing; and
an electronic component having a second connection means supported by and affixed into a circuit board, wherein the first connection means connects to the second connection means directly.

2. The communication system of claim 1, wherein the electronic component is a radio frequency amplifier or a low noise amplifier.

3. The communication system of claim 1, wherein the first connection means includes a connection sleeve and neither the first connector means or the second connector means have a connector housing.

4. The communication system of claim 3, wherein the connection sleeve is securely connected to a coupling post and the coupling post is securely attached to a housing of the duplexer, multiplexer or filter.

5. The communication system of claim 3, wherein the connection sleeve has one solid portion and one hollow portion.

6. The communication system of claim 5, wherein the one hollow portion contains a spring tension mechanism.

7. The communication system of claim 3, wherein an outer surface(s) of the connection sleeve do(es) not touch an inner surface(s) of the access/through/via hole in an electrical conductive manner.

8. The communication system of claim 3, wherein the connection sleeve is insulated/fully surrounded by an insulator or dielectric material.

9. The communication system of claim 1, wherein the second connection means is a connection post.

10. A communication system, comprising:
a receiver front end;
an access panel or door;
a filter, duplexer or multiplexer; and
a radio frequency component wherein the radio frequency component connects directly to the filter, duplexer or multiplexer with a sleeve and a pin.

11. The system of claim 10, wherein the radio frequency component is accessible from outside of the system.

12. The system of claim 10, wherein the access panel or door is connected to the system by hinges or screws and includes gaskets for hermetic or weather resistant sealing.

13. The system of claim 10, wherein the radio frequency component is attached to the filter, duplexer, or multiplexer by a non-permanent means.

14. The system of claim 10, wherein the radio frequency component connects to the filter, duplexer or multiplexer using a housingless connection system comprised of the sleeve and the pin configuration and has repeatable and reproducible connection characteristics and grounding relative to a connector(s) encased in a housing(s).

15. The system of claim of claim 10, wherein the sleeve and pin include a connection interface that utilizes spring force to hold together the radio frequency component and filter, duplexer, or multiplexer.

16. The system of claim 10, wherein the radio frequency component can be removed and replaced independently without removing the filter, duplexer or multiplexer from an installation in an operable base station system.

17. A communication system, comprising:
modular components normally requiring connection together for tuning, wherein the modular components are designed so that they are built and tuned independently.

18. The system of claim 17, wherein the modular components may be assembled without re-tuning the system.

19. The system of claim 17, wherein maintenance or repair may be performed on the modular components without re-tuning the system.

20. The system of claim 17, wherein at least two components are attached together by a spring force or other non-permanent means.
